(19) United States
(12) Patent Application Publication
(10) Pub. No.: US 2023/0294067 A1
(43) Pub. Date: Sep. 21, 2023

(54) Reactor System for Producing and/or Treating Particles in an Oscillating Process Gas Flow

(71) Applicant: Glatt Ingenieurtechnik Gesellschaft mit beschränkter Haftung, Weimar (DE)

(72) Inventors: Frank Ohlendorf, Erfurt (DE); Arne Teiwes, Weimar (DE); Louis Friedrich, Bienstädt (DE); Michael Jacob, Weimar (DE)

(21) Appl. No.: 17/915,639

(22) PCT Filed: Mar. 25, 2021
(86) PCT No.: PCT/EP2021/057707

§ 371 Date: Mar. 3, 2023

(30) Foreign Application Priority Data
Mar. 31, 2020 (DE) 10 2020 204 199.7

(51) Int. Cl. B01J 19/24; B01J 19/00; B01J 8/08; B01J 8/16; F23C 15/00; F23N 1/04; B01J 2/18

(52) U.S. Cl. CPC B01J 19/241; B01J 19/0013; B01J 8/085; B01J 8/087; B01J 8/16; F23C 15/00; F23N 1/042; B01J 2/18; B01J 2208/00504; B01J 2219/00157; B01J 2208/00566

(57) ABSTRACT

A reactor system for the production and/or treatment of particles in an oscillating process gas stream. The reactor system includes a reactor unit that has an upstream feed unit and a downstream discharge unit and a reactor that includes a multiple burner system that has a combustion chamber, an exhaust gas pipe that follows downstream from the combustion chamber, and a plurality of burners. A part of the burners of the multiple burner systems are suitable for production of the oscillating process gas stream. The burners of the multiple burner system are arranged in the combustion chamber of the reactor unit.

### CROSS-REFERENCE TO RELATED APPLICATIONS

This application is the United States national phase of International Application No. PCT/EP2021/057707 filed Mar. 25, 2021, and claims priority to German Patent Application No. 10 2020 204 199.7 filed Mar. 31, 2020, the disclosures of which are hereby incorporated by reference in their entireties.

### BACKGROUND

### Field

The invention relates to a reactor system for the production and/or treatment of particles in an oscillating process gas stream, having a reactor unit that has an upstream feed unit and a downstream discharge unit, wherein the reactor unit has a reactor that has a combustion chamber, an exhaust gas pipe that follows downstream from the combustion chamber, and a reactor that comprises a multiple burner system that has a plurality of burners, wherein part of the burners of the multiple burner system are suitable for producing the oscillating process gas stream, and wherein the burners of the multiple burner system are arranged in the combustion chamber of the reactor unit, and wherein the feed unit has a channel system that has channel ducts, and wherein each burner has a channel duct configured as a feed line for the fuel/combustion gas mixture and/or a channel duct for fuel, configured as a feed line, and a channel duct for combustion gas, in particular combustion air, configured as a feed line.

### DESCRIPTION OF RELATED ART

Reactor systems and methods for the production and/or treatment of particles, preferably of fine particles having an average particle size from 1 nm to 5 mm, in particular nano-scale or nano-crystalline particles, in an oscillating process gas stream, are already known from the state of the art.

Reactor systems configured as acoustic resonators are known, in which an oscillation or pulsation of the process gas is used, with the purpose of producing a resonance oscillation, wherein the latter has an influence, in particular, on acoustic, material (in the case of multi-phase systems, for example) and heat-technology properties (influencing heat transfer, for example), in that the resonance oscillation of the process gas has an effect, in the form of mechanical forces and/or in the form of a change in dwell time, on the solid and/or liquid particles to be produced and/or treated in the process gas, and can be usefully applied for various purposes. Such acoustic resonators are, for example, hollow cavity resonators, in particular Helmholtz resonators, which have inherent resonance frequencies that define a resonance state, in each instance. In this regard, the resonance oscillation can be produced in different ways and can be influenced with regard to its resonance frequency and resonance pressure amplitude.

For the quality of the resonance oscillation in a reactor system, a decisive role is played essentially by the manner of production of the resonance oscillation, the geometry of the reactor system in which the resonance oscillation is to be made usable, the ability to regulate the resonance frequency and/or the resonance pressure amplitude in the reactor system, the material properties of the process gas, which are determined, among other things, by the temperature and the static pressure of the process gas, as well as by the retroactive effects on the reactor system itself.

The German patent application DE 10 2015 005 224 A1 discloses a method for targeted setting and regulation of the amplitudes of the oscillations of the static pressure and/or of the hot gas velocity in a pulsating jet system with or without thermal material treatment/material synthesis, which has at least one burner with which an oscillating (pulsating) flame is produced, and at least one combustion space (resonator), into which the flame is directed. Usually targeted, independent adjustment of the amplitude (oscillation intensity) of the pulsating hot gas stream that results from self-excited, feedback-coupled combustion instability in a pulsating jet furnace or a pulsation reactor is not possible, and therefore neither is an adaptation of the periodic non-stationary combustion process to the selected throughput of the reactor (in the case of material treatment/material synthesis: for example, the educt application rate or the product rate), without a simultaneous but non-desired change in other process parameters (treatment temperature, dwell time or treatment duration) and thereby also of the material properties that are produced. In order to make this possible nevertheless, it is proposed to insert an oscillation volume through which air, fuel or a fuel/air mixture flow upstream from the burner outlet, into supply lines of the burner that run to the burner. Preferably the size of this volume can be infinitely adjustable. In this way, it is possible to change the amplitude of the oscillation.

The German patent application DE 10 2015 006 238 A1 shows a method and an apparatus for thermal material treatment or material conversion, in particular of coarse, granular raw materials, in a pulsating hot gas stream having an independently adjustable frequency and amplitude of the velocity oscillation or the static pressure oscillation of the hot gas stream in a vertically arranged reaction space. Raw material particles that are introduced at the upper end of the vertically arranged reaction space cannot be pneumatically transported by the hot gas stream when an average flow speed of the stream is set, because of their shape, mass, and density, but rather sink down counter to the flow direction. During this sinking time of approximately 1 s to 10 s, thermal treatment of the material to produce the desired product takes place, and the latter is removed from the reactor at the lower end of the reaction pipe, using a gateway system.

A method and an apparatus for thermal treatment of a raw material, having a combustion chamber in which a periodically non-stationary, oscillating flame is burning, for the production of a pulsating exhaust gas stream that flows through a reaction space that follows the combustion chamber, is disclosed in the German patent application DE 10 2016 002 566 A1. In order to achieve the result that the raw material is efficiently treated, it is proposed that an insert that has a cross-sectional surface area that is reduced in size as compared with the reaction space and through which the exhaust gas flows is provided in the reaction space, which insert has a length that is shorter than a total length of the reaction space. In particular, the length of the insert and the geometry of the combustion chamber can be changed, so that the apparatus has two resonators that can be coordinated with one another.

The German patent application DE 10 2018 211 650 A1 relates to an apparatus for the production of particles, in particular of fine, in particular nano-scale or nano-crystalline particles, from at least one raw material. In this regard, the apparatus comprises at least one burner and a combustion chamber that follows the burner, to generate a pulsating hot gas stream, a reaction space section that follows the combustion chamber, and at least one pressure arrangement for setting a resonance behavior and thereby the acoustic pressure within the combustion chamber and/or within the reaction space section.

The technical solutions known from the prior art all have the disadvantage that the reactor systems have only one burner and that the oscillating process gas stream produced in the reactor system cannot be optimally regulated, due to feedback to the reactor system that is configured as an oscillating system, caused by fittings or the like.

### SUMMARY

It is therefore the task of the invention to make available a reactor system that has multiple burners and, at the same time, can optimally regulate the oscillating process gas stream produced in the reactor system, on the basis of feedback caused by fittings or the like.

This task is accomplished, in the case of a reactor system of the type stated initially, in that at least for the part of the burner of the multiple burner system that is suitable for the production of the oscillating process gas stream, each channel duct that is configured as a feed line has a volume stream regulation device. Regulating fittings that have a high regulation precision are suitable as volume stream regulation devices. It is practical if the volume stream regulation device has a regulation precision of less than or equal to 3%, preferably of less than or equal to 2%, particularly preferably of less than or equal to 1%, and most preferably of less than or equal to 0.5% auf. Preferably the volume stream regulation device is configured as a sliding gate valve, regulating valve, regulating cock or an iris shutter that can be regulated.

Volume stream regulation that has great regulation precision is necessary in order to minimize or avoid feedback to the process gas volume stream that is caused by the resonance oscillation. In particular, great regulation precision of the volume stream is necessary when using a divider device, so that a system that is capable of oscillation or oscillates in the operating state can be operated in a stable manner.

According to a further development of the reactor system that is advantageous in this regard, the plurality of burners can be selected, in particular, from the group of ignition burners, pilot burners, ring burners, diffusion burners and/or swirl burners.

For reliable ignition of high-speed flows or flames, as they are present in the multiple burner system, an external, self-monitoring ignition burner is used. The ignition burner is operated with its own fuel supply and combustion gas supply, in particular fuel gas and combustion air. After successful ignition of the pilot burner and the swirl burner configured as a main burner, the ignition burner is removed from the vicinity of the burner outflow or the main flame of the swirl burner by way of a retraction apparatus.

The pilot burner configured as a swirl burner brings about reliable ignition, close to the burner, of the lean pre-mixed main flame of the swirl burner. The thermal output range of the pilot burner preferably lies between 20 kW and 50 kW; the related air quantity regulation range preferably lies between 1.05 and 1.25. The swirl generation of the pilot burner is implemented by means of an axial blade swirl generator having a fixed swirl strength that is dependent on a blade inclination angle.

The swirl burner that is configured as the main burner has two different but coupled functions. For one thing, the main flame of the swirl burner delivers the heat power required for the thermal material treatment, for example drying, calcination and/or phase conversion in the process space or reaction space, including the system heat losses in the case of an adjustable production and/or treatment temperature from the lean pre-mixed combustion. For another thing, the main flame of the swirl burner converts part of the thermal energy from the combustion process into mechanical energy for producing and maintaining a periodically oscillating process gas stream, in which the material treatment takes place. The power range of the swirl burner configured as the main burner preferably lies at 75 kW to 450 kW. The air quantity of the pre-mixture of the main flame of the swirl burner varies, in particular, between 1.3 and 1.8. The swirl production of the swirl burner is implemented by means of infinitely adjustable tangential air inlets having an angle adjustment range of preferably 0° to 45°.

Alternatively to the swirl burner structured as the main burner, the possibility exists of preferably making the main energy input for the thermal material treatment of preferably up to 450 kW available by means of a diffusion burner. If the diffusion burner is used, the swirl burner is not used.

The ring burner serves for adaptation of the total thermal power as well as of the production and/or treatment temperatures of the starting substances to the corresponding process. The ring burner makes partial uncoupling of the average main burner power and of the burner setting for pulsating, oscillating burner operation possible. The power range of the ring burner preferably goes from 0 kW at a pure air stream to approximately 50 kW at a pure air quality of 1.5.

In accordance with an additional advantageous embodiment of the reactor system, the part of the burner of the multiple burner system that is suitable for production of the oscillating process gas stream is configured, in particular, as a diffusion burner or as a swirl burner. In the case of a diffusion burner, it is advantageous if the fuel/combustion air mixture is only formed in the combustion chamber. In contrast to this, a pre-mixed fuel/combustion air mixture is used in the case of the swirl burner, in particular.

According to a further advantageous embodiment of the reactor system, the burners of the multiple burner system are suitable for burning liquid, solid and gaseous fuel. As a result, fuels can be used for combustion in the corresponding burner in a very flexible manner, in different aggregate states.

Preferably the burners of the multiple burner system are arranged concentric to one another. As a result, a very compact structure of the burners of the multiple burner system is guaranteed.

According to an additional advantageous embodiment of the reactor system, the feed unit and the discharge unit have a pressure regulation device, so that the static pressure in the reactor system can be regulated. By means of adapting the static process gas pressure, the acoustic properties of the reactor system can be influenced, so that the reactor system can be adapted, for example, to the application of different starting substances that damp the resonance pressure amplitude of the resonance oscillation.

In accordance with a preferred further development of the reactor system, the reactor unit has multiple reactors that have a multiple burner system. By means of the multiple reactors, the production and treatment processes can be scaled, so that clearly larger amounts of the particles can be produced or treated in a reactor system.

According to an additional advantageous further development of the reactor system, the feed unit and the discharge unit each have a pressure loss production device that produces a pressure loss. In this regard, the pressure loss production devices are configured in such a manner that optionally a resonance state that can be produced in the reactor system can be set. The additional pressure loss brought about in the oscillating system by the pressure loss production device as a function of the acoustic properties of the resonator then corresponds to the resonance pressure amplitude of the resonance oscillation of the process gas. The pressure loss production devices limit the oscillating system of the reactor system in the operating state geometrically and with regard to the process gas volume of the gas column that is formed and is capable of resonance. As a result, it is possible to impose a pulsation on the process gas, while the oscillating system of the reactor system remains the same in terms of its geometric dimensions, and thereby also onto a process gas volume of the gas column that is formed and is capable of resonance, which volume remains the same in the reactor system, and thereby the oscillating system in the reactor system is excited, so as to amplify the pulsation to produce a resonance oscillation of the process gas that has a resonance frequency and a resonance pressure amplitude.

The nature of the pressure loss production device therefore consists of limiting the reactor system in terms of its geometric dimensions, permitting a process gas stream through the reactor system, and, at the same time, preventing the propagation of the resonance oscillation beyond the pressure loss production device, and thereby forming a defined system, capable of oscillation, in the reactor system. The more limited the oscillating system is, the more effective production and propagation of the resonance oscillation in the oscillating system will be. By means of the defined system, capable of oscillation, it is made possible for excitation and propagation of the resonance oscillation to be produced and set continuously, in particular periodically, with regard to its resonance frequency and/or resonance pressure amplitude, with a reasonable expenditure of technology and energy.

Furthermore preferably, a divider device is arranged upstream from the combustion chamber of the reactor unit, wherein the divider device divides up a channel duct configured as a feed line, so that multiple burners can be supplied by the feed line. Preferably it is practical if the channel ducts configured as a feed line after the divider device have the same feed line length and/or the same feed line inside diameter and/or other similar fittings. By means of the aforementioned measures, a uniform distribution of the partial streams of the feed lines is set. Furthermore preferably, each channel duct has a volume stream regulation device.

According to an additional preferred embodiment of the reactor system, the feed unit has a pulsation device. It is advantageous in this regard if the pulsation device is arranged as a channel duct configured as a feed line for the diffusion burner or swirl burner configured as a main burner. By means of the additional pulsation device, situated upstream from a main burner, a resonance frequency and/or a resonance pressure amplitude produced by the combustion process can have a resonance frequency and/or a resonance pressure amplitude produced by the pulsation device superimposed on it. In this way, it is possible to reach different resonance states of the system that is capable of oscillation or oscillates during operation, in the same reactor system.

### BRIEF DESCRIPTION OF THE DRAWINGS

In the following, the invention will be explained in greater detail using the attached drawing, which shows in

FIG. 1 a schematic representation of a first embodiment of a reactor system,

FIG. 2 a sectional representation of a first multiple burner system of the reactor system shown in FIG. 1, having burners arranged concentric to one another,

FIG. 3 a top view of the first multiple burner system shown in FIG. 2,

FIG. 4 a schematic representation of a second embodiment of a reactor system,

FIG. 5 a sectional representation of a second multiple burner system having burners arranged concentric to one another,

FIG. 6 a top view of the second multiple burner system, and

FIG. 7 a schematic representation of a third embodiment of a reactor system.

### DETAILED DESCRIPTION

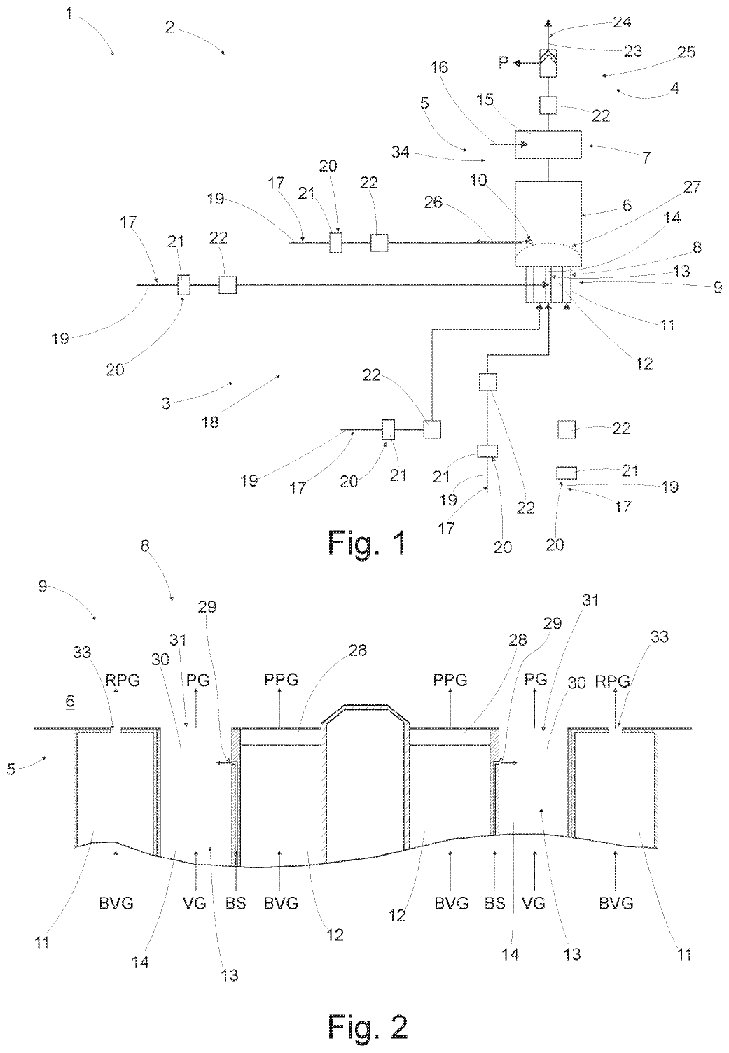

FIG. 1 shows a schematic representation of a first embodiment of a preferred reactor system 1 for the production and/or treatment of particles in an oscillating process gas stream.

The reactor system 1 that forms a system 2 that is capable of oscillation or oscillates during operation has a reactor unit 5 that has an upstream feed unit 3 and a downstream discharge unit 4. The reactor unit 5 has a reactor 34 that comprises a combustion chamber 6, an exhaust gas pipe 7 that follows the combustion chamber 6 downstream, also referred to as a resonance pipe, and a reactor 34 that comprises a multiple burner system 9 that has a plurality of burners 8.

The burners 8 of the multiple burner system 9 are arranged in the combustion chamber 6 of the reactor unit 5. In the first exemplary embodiment shown in FIG. 1, the multiple burner system 9 comprises an ignition burner 10, a ring burner 11, a pilot burner 12, and a swirl burner 14 configured as the main burner 13. The burners 8 of the multiple burner systems 9 are arranged concentric to one another and are suitable for burning liquid, solid, and gaseous fuel. In this regard, a part of the burners 8 of the multiple burner systems 9 is suitable for production of the oscillating process gas stream. In the first embodiment, the oscillating or pulsating process gas stream is produced by means of the swirl burner 14 configured as a main burner 13.

After combustion, the hot, oscillating or pulsating process gas flows out of the combustion chamber 5 in the direction of the exhaust gas pipe 7 that is configured as a reaction space 15. In this regard, the combustion process is a self-regulating periodic non-stationary combustion process. Application of the starting material in the reaction space 15 takes place by means of the application device 16.

The application device 16 is preferably configured for the introduction of liquids or solids into the reaction space 15 of the reactor unit 5.

Liquids or liquid raw materials (precursors) can be introduced into the reaction space 15 preferably as a solution, suspension, melt, emulsion or as a pure liquid. The introduction of the liquid raw materials or liquids preferably takes place continuously. For the introduction of liquids into the reaction space 15 of the reactor unit 5, an application device 16 is preferably used, such as, for example, spray nozzles, feed pipes or droplet dispensers, which are configured, for example, as single-substance or multi-substance nozzles, pressure nozzles, nebulizers (aerosol) or ultrasound nozzles.

In contrast to this, for the introduction of solids, for example powders, granulates or the like, into the reactor unit 5, preferably into the reaction space 15, an application device 16 is preferably used, such as, for example, a double flap, a rotary feeder, a batching valve or an injector.

The introduction of the starting substance in the form of a liquid or of a solid can take place in or counter to the flow direction of the process gas PG that flows through the reactor system 1.

Preferably the starting substance is introduced into the reactor system 1, preferably into the reaction space 15, using a carrier gas. In an embodiment that is not illustrated, application takes place into the combustion chamber 6 of the reactor unit 5. The decision as to whether the starting substance is introduced into the reactor system 1 in or counter to the flow direction of the process gas depends decisively on the shape, mass, and density of the starting substance at a set average flow speed of the process gas PG. As a result, the possibility exists of also thermally treating starting substances that cannot be transported in the reactor system 1 by means of the process gas PG.

The starting substance is treated thermally in the treatment zone of the reactor 5, preferably in the reaction space 15, so that the particles P to be produced, preferably the inorganic or organic nano-particles, particularly preferably the nano-crystalline metal oxide particles, are formed. The region in which the starting substances are treated thermally is defined as the treatment zone.

The feed unit 3 comprises a channel system 18 that has channel ducts 17, and wherein each burner 8 has a channel duct 17 configured as a feed line 19 for the fuel/combustion gas mixture BVG, or a channel duct 17 for fuel BS configured as a feed line 19 and a channel duct 17 for combustion gas VG, in particular combustion air, configured as a feed line 19, in each instance.

At least for the part of the burners 8 of the multiple burner systems 9 that are suitable for production of the oscillating process gas stream, here the swirl burner 14 configured as the main burner 13, each channel duct 17 configured as a feed line 19 has a volume stream regulation device 20. In the embodiment of the reactor system 1 shown in FIG. 1, each channel duct 17 configured as a feed line 19 comprises a volume stream regulation device 20.

Preferably the volume stream regulation device 20 is configured as a sliding gate valve, regulating valve, regulating cock or an iris shutter that can be regulated. In the embodiment shown, regulating valves 21 are built into the reactor system 1. The regulation precision of the volume stream regulation devices 20 configured as regulating valves 21 is less than or equal to 3%, preferably less than or equal to 2%, particularly preferably less than or equal to 1%, and most preferably less than or equal to 0.5%.

Furthermore, each channel duct 17 of the feed unit 3, configured as a feed line 19, has a pressure loss production device 22 that produces a pressure loss. Also, each channel duct 24 of a channel system 25 of the discharge unit 4, configured as a discharge line 23, comprises a pressure loss production device 22. The pressure loss production devices 22 are configured in such a manner that optionally a resonance state that can be produced in the reactor system 1 can be set.

For reliable ignition of the oscillating or pulsating process gas, an external, self-monitoring ignition burner 10 is used. The ignition burner 10 is operated with its own channel duct 17 for the fuel/combustion gas mixture BVG, configured as a feed line 19. After successful ignition of the pilot burner 12 and the swirl burner 14 configured as the main burner 13, the ignition burner 10 can be removed from the region 27 of the burner outflow or the main flame of the swirl burner 14 by way of a displacement device 26. When ignition occurs again, the ignition burner 10 can be moved into the region 27 of the burner outflow.

In FIG. 2, a sectional representation of a first multiple burner system 9 having burners 8 that are arranged concentric to one another, of the reactor system 1 shown in FIG. 1, is shown. The concentrically arranged burners 8 are configured, from the outside to the inside, as a ring burner 11, as a swirl burner 14 configured as a main burner 13, and as a pilot burner 12.

The pilot burner 12, also configured as a swirl burner, brings about reliable ignition, close to the burner, of the lean pre-mixed main flame of the swirl burner 14. The fuel/combustion gas mixture BVG enters into the combustion chamber 6 of the reactor unit 5 in a swirled manner, as the pilot burner process gas PPG. The thermal power range of the pilot burner 12 preferably lies between 20 kW and 50 kW; the related air quantity regulation range preferably lies between 1.05 and 1.25. The swirl production of the pilot burner 12 is implemented by means of an axial blade swirl producer 28 that has a fixed swirl strength, which depends on a blade inclination angle.

The swirl burner 14 configured as a main burner 13 has two different functions. For one thing, the main flame of the swirl burner 14 provides the heat output required for the thermal material treatment, for example drying, calcination and/or phase conversion. In this regard, the production temperature and/or treatment temperature of the starting substances, which can be set, lies between 100° C. to 3,000° C., preferably at 240° C. to 2200° C., particularly preferably at 240° C. to 1800° C., very particularly preferably at 650° C. to 1800° C., most preferably at 700° C. to 1500° C. from the lean pre-mixed combustion. For another thing, the main flame of the swirl burner 14 converts part of the thermal energy from the combustion process into mechanical energy for producing and maintaining a periodically oscillating process gas stream, in which the material treatment takes place. The power range of the swirl burner 14 configured as the main burner 13 preferably lies at 75 kW to 450 kW. The air quantity of the main flame of the swirl burner 14 varies, in particular, between 1.3 and 1.8. The swirl production of the swirl burner 14 is implemented by means of infinitely adjustable tangential air inlets, not illustrated, that have an angle adjustment range of preferably 0° to 45°.

The fuel BS flows into the combustion gas swirl burner channel 30 through which combustion gas VG flows, by way of fuel exit openings 29, and is pre-mixed there. The pre-mixed fuel/combustion gas mixture enters into the combustion chamber 6 of the reactor unit 5 by way of a swirl burner exit opening 31 and ignites.

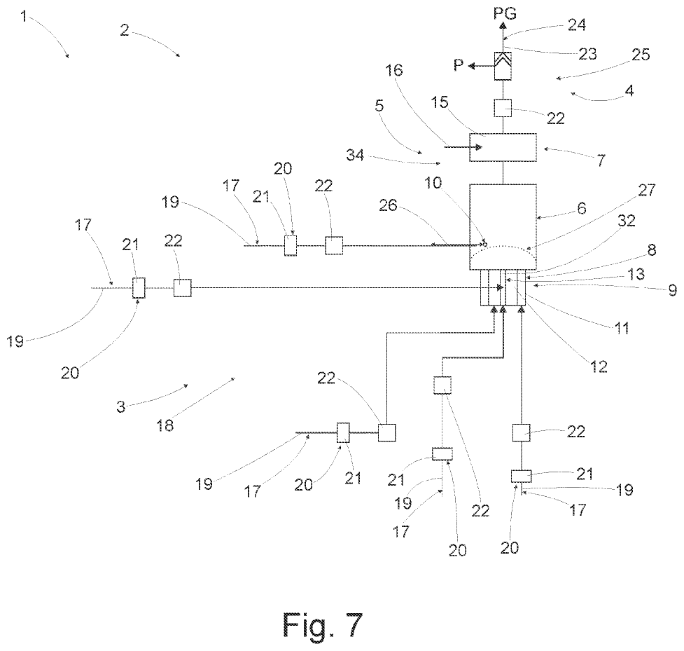

Alternatively to the swirl burner 14 structured as the main burner 13, the possibility exists of making the main energy input for thermal material treatment, at preferably up to 450 kW, available by way of a diffusion burner 32, illustrated here in FIG. 7.

The ring burner 11 serves for adaptation of the total thermal power as well as of the production temperatures and/or treatment temperatures to the corresponding process. The ring burner 11 allows partial uncoupling of the average main burner power and the burner setting for pulsating, oscillating main burner operation. The power range of the ring burner preferably ranges from 0 kW at an air flow to up to approximately 50 kW at a pure air quantity of 1.5. The fuel/combustion gas mixture BVG enters into the combustion chamber 6 of the reactor unit 5 as ring burner process gas RPG, by way of ring burner exit openings 33.

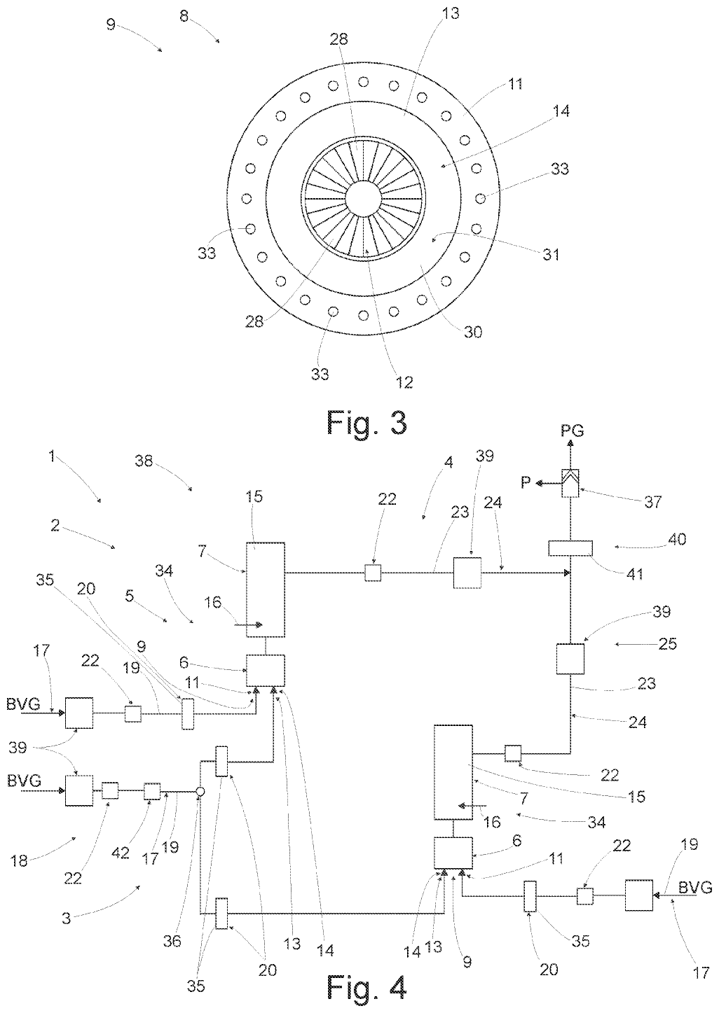

FIG. 3 shows a top view of the first multiple burner system 9 shown in FIG. 2 and explained in greater detail, having the ring burner 11, swirl burner 14, and pilot burner 12, arranged from the outside to the inside.

In FIG. 4, a schematic representation of a second embodiment of a reactor system 1 is shown.

The reactor system 1 has a reactor unit 5 that has two reactors 34, preceded by a feed unit 3 and followed by a discharge unit 4.

The process gas PG that flows through the reactor system 1 enters into the reactor unit 5 of the reactor system 1 by way of the feed unit 3, and from there exits by way of the discharge unit 4. The feed unit 3 comprises a channel system 18 that has channel ducts 17, and wherein each burner 8 has a channel duct 17 for the fuel/combustion gas mixture BVG, configured as a feed line 19. The discharge unit 4 also comprises a channel system 25 that has channel ducts 24 configured as discharge lines 23.

The reactor 34 of the reactor unit 5 has a combustion chamber 6, an exhaust gas pipe 7 configured as a reaction space 15, wherein the exhaust gas pipe 7 follows the combustion chamber 6 downstream. The combustion chamber 6 of the reactor 34 has a multiple burner system 9 having a plurality of burners 8, here two burners 8, namely a ring burner 11 and a swirl burner 14. Both the ring burner 11 and the swirl burner 14 burn a pre-mixed fuel/combustion gas mixture BVG.

The process gas PG that flows through the reactor system 1 is warmed or heated to a production temperature and/or treatment temperature by means of a swirl burner 14 configured as the main burner 13. The temperature for production or thermal treatment of the at least one starting substance is preferably between 100° C. and 3000° C., preferably 240° C. to 2200° C., particularly preferably 240° C. to 1800° C., very particularly preferably 650° C. to 1800° C., most preferably 700° C. to 1500° C.

By means of the combustion process, a pulsation that has a pulsation frequency and a pulsation pressure amplitude is imposed on the process gas PG that flows through the reactor system 1. The pulsation preferably has a pulsation pressure amplitude of 0.1 mbar to 350 mbar, particularly preferably of 1 mbar to 200 mbar, very particularly preferably of 3 mbar to 50 mbar, most preferably of 10 mbar to 40 mbar.

Furthermore, the possibility exists of setting the pulsation frequency of the process gas PG by means of a pulsation device 42, independently of the pulsation pressure amplitude. The pulsation frequency of the process gas PG that flows through the reactor system 1, while pulsating, can be overlaid and thereby also set by means of the pulsation device 42, preferably in the frequency range of 1 Hz to 2000 Hz, preferably between 1 Hz to 500 Hz, particularly preferably between 40 Hz and 160 Hz.

Accordingly, a pulsation that has a pulsation frequency and a pulsation pressure amplitude can also be imposed on the process gas PG that flows through the reactor system 1, by means of the pulsation device 42. The pulsation preferably has a pulsation pressure amplitude of 0.1 mbar to 350 mbar, particularly preferably of 1 mbar to 200 mbar, very particularly preferably of 3 mbar to 50 mbar, most preferably of 10 mbar to 40 mbar.

The pulsation device 42 is preferably configured as a pulsation device 42 that works without a flame. It is practical if the pulsation device 42 is configured as a compression module, in particular as a piston, or as a rotary vane or as a modified turnstile.

Downstream from the feed unit 3, the exhaust gas pipe 7 that forms a reaction space 15 is arranged on the reactor 34 of the reactor unit 5. In the reaction space 15, the starting substance is introduced into the pulsating process gas PG that flows through the reactor system 1 and the reactor 34 of the corresponding reactor unit 5, by means of an application device 16. The application takes place as has already been explained in greater detail with regard to FIG. 1.

At least for the part of the burners 8 of the multiple burner system 9 that is suitable for production of the oscillating process gas stream, here the swirl burner 14 configured as the main burner 13, and the ring burner 11, each channel duct 17 configured as a feed line 19 has a volume stream regulation device 20. Preferably the volume stream regulation device 20 is configured as a sliding gate valve, regulating valve, regulating cock or an iris shutter that can be regulated. In the embodiment shown, iris shutters 35 that can be regulated are built into the reactor system 1. The regulation precision of the volume stream regulation devices 20 configured as iris shutters 35 is less than or equal to 3%, preferably less than or equal to 2%, particularly preferably less than or equal to 1%, and most preferably less than or equal to 0.5%. The volume stream regulation device 20 that has a great regulation precision is necessary so as to minimize or prevent feedback to the process gas volume stream caused by the resonance oscillation. In particular, great regulation precision of the process gas volume stream is necessary when using a divider device 36, so that the system 2, which is capable of oscillation or oscillates in the operating state can be operated in a stable manner.

Upstream from the combustion chambers 6 of the reactors 34 of the reactor unit 5, a divider device 36 is arranged in the feed line 19 for the fuel/combustion gas mixture BVG for the swirl burner 14. The feed line 19 is configured in such a manner that each feed line 19 between the divider device 36 and the corresponding burner chamber 6 of the reactor 34 of the reactor unit 5 has a pressure loss, wherein the pressure loss in each feed line 19 is essentially the same size. This is achieved in that in particular, the feed line 19 [sic-singular] have the same feed line length and/or the same feed line inside diameter and/or other fittings that are the same.

The discharge unit 4 that follows the reactor unit 5 comprises a separation apparatus 37. The separation apparatus 37, in particular a filter, preferably a hot gas filter, very particularly preferably a tubular, metal or fiberglass filter, a cyclone or a washer, separates the thermally treated particles P from the pulsating, hot process gas stream that flows through the reactor system 1. The particles P that are removed from the process gas stream are drawn off from the separation apparatus 37 and processed further. If necessary, the particles P that have been thermally treated in the reactor system 1 are subjected to further subsequent treatment steps, such as, for example, suspension, grinding or calcination. The non-charged process gas PG is conducted away into the environment.

The dwell time of the one starting substance introduced into the reactor system lies between 0.1 s and 25 s. Closed-cycle operation of the process gas PG is possible. If applicable, partial removal of the process gas PG from the circuit is also possible.

Furthermore, the reactor system 1, which has a static process gas pressure, is configured as an acoustic resonator 38, which has inherent resonance frequencies that each define a resonance state. The process gas PG can form a gas column that is capable of resonance in the reactor system 1, so that the resonator 38 can be excited by means of the pulsation frequency and/or the pulsation pressure amplitude of the pulsation that is generated by means of the combustion process or a pulsation device that is not illustrated, and in the resonance state, the pulsation can be amplified to produce a resonance oscillation of the process gas

PG that has a resonance frequency and a resonance pressure amplitude.

The feed unit 3 and the discharge unit 4 each comprise a pressure loss production device 22 that produces a pressure loss, wherein the pressure loss production devices 22 are configured in such a manner that optionally one of the resonance states of the resonator 38 can be set. The pressure loss production devices 22 limit a system 2 of the reactor system 1 that is capable of oscillation and oscillates in the operating state, geometrically and with regard to the process gas volume of the gas column that is formed and is capable of resonance. The pressure loss production devices 22 thereby prevent propagation of the resonance oscillation beyond the pressure loss production devices 22. The more limited the system 2 is, which is capable of oscillation or oscillates in the operating state, the more effective production and propagation of the resonance oscillation in the system 2 will be.

The pressure loss production devices 22 are arranged in the reactor system 1, in particular in the feed unit 3 and the discharge unit 4, so that their respective positions can be changed, wherein in the operating state, the pressure loss production devices 22 cannot be changed in terms of the position that has previously been set. In this way, it is ensured that the system 2, which oscillates in the operating state, does not change.

In the case of certain processes, it is advantageous to be able to set or regulate the static pressure in the reactor system 1. For this purpose, each channel duct 17 of the feed unit 3, configured as a feed line 19, has a pressure regulation device 37. Also, each channel duct 24 of a channel system 25 of the discharge unit 4, configured as a discharge line 23, comprises a pressure regulation device 39. Feed unit 3 and discharge unit 4 have the pressure regulation devices 389, so that the static pressure in the reactor system 1 can be regulated.

The pressure loss production devices 22 that limit the system 2, which is capable of oscillation or oscillates in the operating state, are arranged within the process gas regulation device 39. Upstream from the reactor unit 5, the pressure regulation device 15 39 therefore arranged upstream from the pressure loss production devices 22, and downstream from the reactor unit 5, it is arranged downstream from the pressure loss production devices 22. Without such a pressure regulation device 39, the static process gas pressure in the reactor system 1 corresponds to atmospheric pressure.

By means of adapting the static process gas pressure in the reactor system 1, an influence can be exerted on the properties of the acoustic resonator 38. Flow resistances, acoustic phenomena, and changes in the material properties of the process gas as well as of the starting substance applied to it can damp the resonance oscillation. The energy expenditure for resonance oscillation production is accordingly increased and/or the ability to regulate the resonance oscillation is influenced. In particular, the reactor system 1 can be adapted, in this way, to the factors that damp the resonance pressure amplitude of the resonance oscillation.

A higher static process gas pressure changes the acoustic properties of the resonator 38, for example to the effect that its inherent resonance frequencies shift. For this reason, excitation of the reactor system 1 is possible only by means of the imposition of other pulsation frequencies onto the process gas.

In addition, the reactor system 1 can also comprise a process gas cooling segment 40, in particular a quenching apparatus 41, which is used to stop the reaction taking place in the reactor system 1 at a certain point in time and/or to adapt the process gas stream to a maximally permissible temperature of a subsequent separation device 37, in particular a filter. The process gas cooling segment 40, preferably the quenching apparatus 41, is arranged, here, in the discharge unit 4, upstream from the separation device 37 that is configured as a filter.

To stop the reaction and/or to limit the temperature of the process gas stream to a maximally permissible temperature of a subsequent separation device 37, a cooling gas is mixed into the pulsating, hot process gas stream that flows through the reactor system 1, by way of the process gas cooling segment 40, preferably air, particularly preferably cold air or compressed air. The air mixed in by way of the process gas cooling segment can be filtered or conditioned beforehand, if necessary, depending on the requirements. Furthermore, it is possible, alternatively to mixing in air or gas, to undertake injection of an evaporating liquid, for example of solvents or liquefied gases, but preferably of water.

The process gas cooling segment 40 arranged in the reactor system 1 as a quenching apparatus 41 can have fittings or is built into the reactor system 1 without fittings. Other gases, such as, for example, nitrogen (N₂), argon (Ar), other inert gases or noble gases or the like can also be used as a cooling gas.

Furthermore, the discharge device 4 has at least a plurality of discharge lines 23 that corresponds to the plurality of the reactors 34 of the reactor unit, wherein each discharge line 23 has a pressure loss production device 22.

The discharge lines 23 are brought together, and the particles P are separated from the process gas stream, preferably from the hot process gas stream by way of the separation apparatus 37.

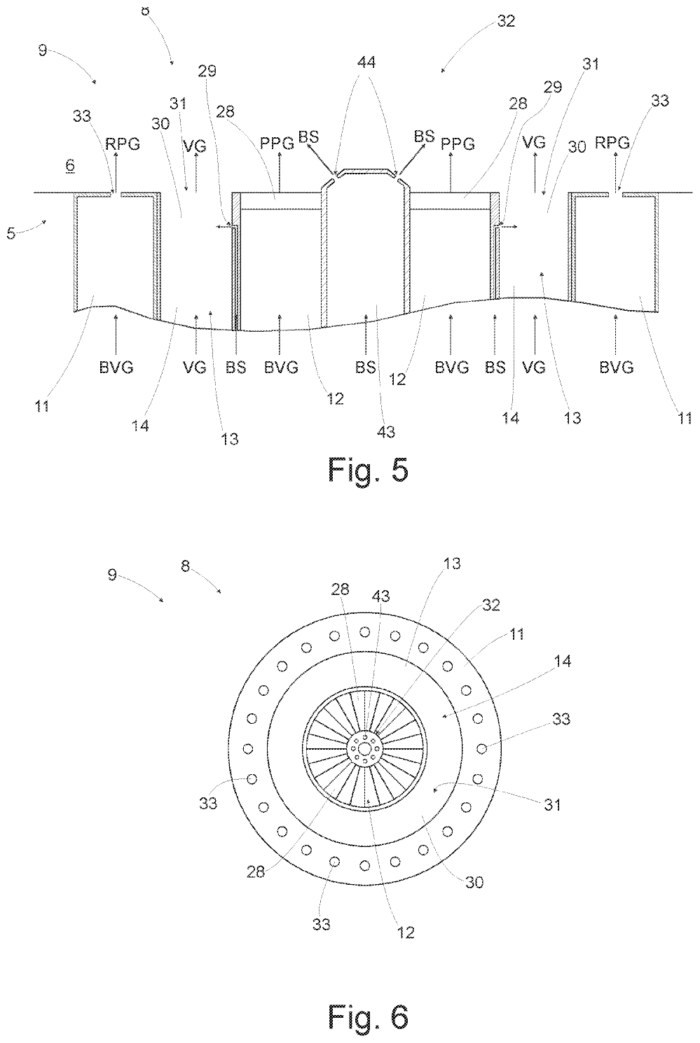

In FIG. 5, a sectional representation of a second multiple burner system 9 for a reactor system 1, having burners 8 arranged concentrically to one another, is shown. The concentrically arranged burners 8 are configured, from the outside to the inside, as a ring burner 11, as a swirl burner 14 configured as a main burner 13, as a pilot burner 12, and as a diffusion burner 32 configured as a main burner 13. The swirl burner 14 and diffusion burner 32 can be used and operated alternatively or together.

The pilot burner 12 configured as a swirl burner brings about, as was already described for FIG. 2, reliable ignition, close to the burner, of the lean pre-mixed main flame of the swirl burner 14 or, alternatively, of the diffusion burner 32. The fuel/combustion gas mixture BVG enters into the combustion chamber 6 of the reactor unit 5 in a swirled manner, as pilot burner process gas PPG. The thermal power range of the pilot burner 12 preferably lies between 20 kW and 50 kW; the related air quantity regulation range preferably lies between 1.05 and 1.25. The swirl generation of the pilot burner 12 is implemented by means of an axial blade swirl generator 26 having a fixed swirl strength that is dependent on a blade inclination angle.

The swirl burner 14 that is configured as the main burner 13 has two different functions. For one thing, the main flame of the swirl burner 14 delivers the heat power required for the thermal material treatment, for example drying, calcination and/or phase conversion. In this regard, the adjustable production and/or treatment temperature of the starting substances lies between 100° C. to 3,000° C., preferably 240° C. to 2200° C., particularly preferably 240° C. to 1800° C., very particularly preferably 650° C. to 1800° C., most preferably 700° C. to 1500° C. from the lean pre-mixed combustion. For another thing, the main flame of the swirl burner 14 converts part of the thermal energy from the combustion process into mechanical energy for producing and maintaining a periodically oscillating process gas stream, in which the material treatment takes place. The power range of the swirl burner 14 configured as the main burner 13 preferably lies at 75 kW to 450 kW. The air quantity of the pre-mixture of the main flame of the swirl burner 14 varies, in particular, between 1.3 and 1.8. The swirl production of the swirl burner 14 is implemented by means of infinitely adjustable tangential air inlets having an angle adjustment range of preferably 0° to 45°.

The fuel BS flows into the swirl burner channel 30 through which combustion gas VG flows, by way of fuel exit openings 29, and is premixed there. The pre-mixed fuel/combustion gas mixture enters into the combustion chamber 6 of the reactor unit 5 by way of a swirl burner exit opening 31.

Alternatively to the swirl burner 14 configured as the main burner 13, the possibility exists of making the main energy input to the thermal material treatment of preferably up to 450 kW by way of a diffusion burner 32. If the diffusion burner 32 is made available as a main burner, the swirl burner 14 is preferably not in use.

The diffusion burner 32 configured as a main burner 13 has the same functions as the swirl burner 14 described above. For one thing, the main flame of the diffusion burner 32 delivers the heat power required for the thermal material treatment, for example drying, calcination and/or phase conversion. In this regard, the adjustable production and/or treatment temperature of the starting substances lies between 100° C. to 3,000° C., preferably 240° C. to 2200° C., particularly preferably 240° C. to 1800° C., very particularly preferably 650° C. to 1800° C., most preferably 700° C. to 1500° C. from the lean pre-mixed combustion. For another thing, the main flame of the diffusion burner 32 converts a part of the thermal energy from the combustion process into mechanical energy for producing and maintaining a periodically oscillating process gas stream, in which the material treatment takes place. The power range of the diffusion burner 14 configured as a main burner 13 preferably lies at 75 kW to 450 kW. The fuel BS flows into the combustion chamber 6 by way of a fuel channel 43 and by way of fuel exit openings 44, while the combustion gas VG flows into the combustion chamber 6 through the VG swirl burner channel 30. The fuel BS and combustion gas VG, in particular combustion air, mix in the combustion chamber 6 and ignite there.

The ring burner 11 serves for adapting the total thermal power as well as the production and/or treatment temperatures to the process, in each instance. The ring burner 11 allows partial uncoupling from the average main burner power and setting the burner for pulsating, oscillating main burner operation. The power range of the ring burner preferably ranges from 0 kW at a pure air stream to approximately 50 kW at a pure air quantity of 1.5. The fuel/combustion gas mixture BVG enters into the combustion chamber 6 of the reactor unit 5, as ring burner process gas RPG, by way of ring burner exit openings 33.

FIG. 6 shows a top view of the first multiple burner system 9 shown in FIG. 5 and explained in greater detail, having the ring burner 11, swirl burner 14, pilot burner 12, and diffusion burner 32, arranged from the outside to the inside.

FIG. 7 shows a schematic representation of a third embodiment of a preferred reactor system 1 for the production and/or treatment of particles in an oscillating process gas stream.

The embodiment shown in FIG. 7 corresponds to the reactor system 1 described for FIG. 1, wherein the swirl burner 14 has been replaced by a diffusion burner 32 configured as a main burner 13, which now produces the oscillating or pulsating process gas stream.

1. A reactor system for the production or treatment of particles in an oscillating process gas stream, comprising:
a reactor unit that has an upstream feed unit and a downstream discharge unit,
wherein the reactor unit has a reactor that comprises a multiple burner system that has a combustion chamber, an exhaust gas pipe that follows downstream from the combustion chamber, and a plurality of burners, wherein a part of the burners of the multiple burner system are suitable for production of the oscillating process gas stream, and wherein the burners of the multiple burner system are arranged in the combustion chamber of the reactor unit, and
wherein the feed unit has a channel system that has channel ducts, and wherein each burner has a channel duct for the fuel/combustion gas mixture configured as a feed line and/or a channel duct for fuel configured as a feed line and a channel duct for combustion gas, configured as a feed line wherein of the multiple burner systems suitable for the production of the oscillating process gas stream, each channel duct configured as a feed line has a volume stream regulation device.

2. The reactor system according to claim 1, wherein the plurality of burners are selected from the group of ignition burners, pilot burners, ring burners, diffusion burners, and swirl burners.

3. The reactor system according to claim 1, wherein the part of the burners of the multiple burner system suitable for the production of the oscillating process gas stream is configured as a diffusion burner or as a swirl burner.

4. The reactor system according to claim 1, wherein the burners of the multiple burner system are suitable for burning liquid, solid, and gaseous fuel.

5. The reactor system according to claim 1, wherein the burners of the multiple burner system are arranged concentrically to one another.

6. The reactor system according to claim 1, wherein the volume stream regulation device is configured as a sliding gate valve, regulating valve, regulating cock or an iris shutter that can be regulated.

7. The reactor system according to claim 1, wherein the volume stream regulation device has a regulation precision of less than or equal to 3%.

8. The reactor system according to claim 1, wherein the feed unit and the discharge unit have a pressure regulation device, so that the static pressure in the reactor system can be regulated.

9. The reactor system according to claim 1, wherein the reactor unit has multiple reactors that have a multiple burner system.

10. The reactor system according to claim 1, wherein the feed unit and the discharge unit each comprise a pressure loss production device that produces a pressure loss.

11. The reactor system according to claim 10, wherein the pressure loss production devices are configured in such a manner that a resonance state that can be produced in the reactor system can be set.

12. The reactor system according to claim 1, wherein a divider device is arranged upstream from the combustion chamber of the reactor unit, wherein the divider device divides a channel duct configured as a feed line, so that multiple burners can be supplied by means of the feed line.

13. The reactor system according to claim 1, wherein the feed unit has a pulsation device.

14. The reactor system according to claim 13, wherein the pulsation device is arranged in a channel duct configured as a feed line for the diffusion burner or swirl burner configured as a main burner.

15. The reactor system according to claim 1, wherein the volume stream regulation device has a regulation precision of less than or equal to 2%.

16. The reactor system according to claim 1, wherein the volume stream regulation device has a regulation precision of less than or equal to 1%.

17. The reactor system according to claim 1, wherein the volume stream regulation device has a regulation precision of less than or equal to 0.5%.
